(19) United States
(12) Patent Application Publication
(10) Pub. No.: US 2021/0400878 A1
(43) Pub. Date: Dec. 30, 2021

(54) Modular Power Unit and Tool Using a Modular Power Unit

(71) Applicant: TECHTRONIC CORDLESS GP, Anderson, SC (US)

(72) Inventors: Brian Ron Vines, Guangdong (CN); Jian Zhong Guo, Guangdong (CN); Yuan Qing Jia, Guangdong (CN); Hei Man Lee, Kwai Chung (CN)

(21) Appl. No.: 17/288,416

(22) PCT Filed: Dec. 13, 2018
(86) PCT No.: PCT/CN2018/120896

§ 371 Date: Apr. 23, 2021

(51) Int. Cl. A01D 69/02; A01D 34/00; A01D 34/68; H02K 5/04; H02K 7/14; H02K 7/10; H02K 7/116; H02P 7/18

(52) U.S. Cl. CPC A01D 69/02; A01D 34/006; A01D 34/6806; H02K 5/04; A01D 2101/00; H02K 7/1004; H02K 7/116; H02P 7/18; H02K 7/14

(57) ABSTRACT

A modular power unit (2; 200) for use with a power tool (1; 101; 102; 103) is provided. The modular power unit comprises a housing (3, 5, 7; 201); a motor (24); and a controller (23) arranged to control an operation of the motor (24), wherein the motor and the controller are at least partially enclosed by the housing. A power tool comprising the modular power unit is also provided.

### FIELD OF THE INVENTION

The present invention relates to a modular power unit for use with a power tool. The present invention also relates to a power tool comprising the modular power unit.

### SUMMARY OF THE INVENTION

According to a first aspect of the present invention, there is provided a modular power unit for use with a power tool, comprising: a housing; a motor; and a controller arranged to control an operation of the motor; wherein the motor and the controller are at least partially enclosed by the housing.

The modular power unit may be used with multiple types of power tools, including, for example, mowers, tillers, brush cutters, trimmers, or other suitable types of power tools. In general, the modular power unit is removably attachable with the power tool. Further, the modular power unit contains a motor and a controller controlling an operation of the motor, and is essentially an electrical module separable from the particular mechanical structures of the power tools. In this way, the modular power unit can be serviced, upgraded, or replaced separately from the power tools.

The motor and the controller may be enclosed by the housing. The controller may be an electric controller, in particular, a microcontroller.

The modular power unit may further comprise a coupling which is operable to couple the motor to the power tool so as to allow the motor to drive the power tool.

The coupling may be operable to couple the motor to a transmission assembly of the power tool.

Advantageously, the modular power unit may be used with various types of power tools having different driven speed and torque requirements. Particular driven speed and torque requirements may be achieved by adjusting the output speed of the motor and/or adjusting the transmission ratio of the transmission assembly.

The coupling may comprise mateable formations engagable with complementary mateable formations of the power tool. The mateable formations may comprise interlocking teeth.

The transmission assembly may comprise a gearbox, a gear train, and a belt-drive transmission assembly, etc.

The modular power unit may further comprise a reduction gearbox coupled to the motor.

The reduction gearbox may comprise an input shaft and an output shaft, with the input shaft coupled to a shaft of the motor. The output shaft of the planetary gearbox may be coupled to the coupling. Advantageously, the reduction gearbox enhances the output torque of the motor by reducing the rotational speed of the motor.

The reduction gearbox may be a planetary reduction gearbox.

The motor may be a brushless DC motor.

In general, the brushless DC motor is able to achieve a high rotational speed at a relatively small size. Using the brushless DC motor together with the reduction gearbox, the modular power unit is able to produce a relatively high torque at a reasonable rotational speed while having a small overall size. This may allow the modular power unit to be used with a wide range of power tools.

The controller may be configured to receive data indicative of a characteristic of the power tool to be used with the modular power unit, and control an operation of the motor based upon the received data.

The data indicative of a characteristic of the power tool may comprise data indicative of a type of the power tool.

In this way, the operation of the motor can be adjusted or optimised based upon the characteristic of the power tool to be used with the modular power unit. In particular, the controller may control the rotational speed and/or the output torque of the motor based upon the received data.

The modular power unit may further comprise a reader which is arranged to obtain the data indicative of a characteristic of the power tool by interacting with an identifier of the power tool.

The reader may take various different forms, depending upon the identifier. For example, the identifier and the reader may be a bar code and a scanner, a RFID and an RFID reader, an optical feature (e.g., an image) and an electromagnetic sensor (e.g., a camera), or a pattern of mechanical structures (e.g., an array of protrusions) and force sensors for sensing the mechanical structures.

The reader may be provided on the coupling.

Advantageously, by providing the reader on the coupling, the coupling is able to identify the power tool at the time of coupling the power unit to the power tool.

The modular power unit may further comprise a cooling mechanism configured to cool at least a part of the modular power unit.

The cooling mechanism improves the heat dissipation of the modular power unit, and allows the modular power unit to have a relatively compact design.

The cooling mechanism may comprise at least one of a cooling fan and a heat sink.

The modular power unit may further comprise a fastener for removably fastening the modular power unit to the power tool.

The fastener may be attached to the housing. The fastener may comprise a bayonet mount (i.e., a twist lock). Other types of fasteners may be used.

The housing may be of a generally cylindrical shape.

The generally cylindrical-shaped housing provides a smooth outer surface and allows the modular power unit to be easily handled, transported and stored.

The housing may be configured to removably receive a battery for powering the motor.

Alternatively, the battery may be accommodated in a battery housing separate from the housing of the modular power unit.

The modular power unit may further comprise a battery for powering the motor.

According to a second aspect of the present invention, there is provided a power tool comprising a modular power unit according to the first aspect.

The power tool may comprise at least one of a mower, a tiller, a brush cutter, a trimmer and other, larger, power tools.

The power tool may further comprise a coupling for engaging with the coupling of the modular power unit.

The power tool may further comprise an identifier indicative of a type of the power tool.

The identifier may be provided on the coupling of the power tool.

The power tool may further comprise a battery engaging feature configured to receive a battery for powering the modular power unit.

The battery engaging feature may comprise a receptacle for receiving a battery.

The power tool may further comprise a deck comprising a belt-drive transmission assembly. The modular power unit may be removably installable on the desk, and the modular power unit and the deck may be configured such that the motor is operatively connected to the belt-drive transmission assembly when the modular power unit is installed on the deck.

The deck may be a mower deck and the power tool may be a mower.

The modular power unit is a single module. The deck forms a separate module of the power tool. This modular design of the power tool improves the flexibility of assembling and using the power tool and allows the modular power unit to be compatible with different decks, such as decks of different sizes. Further, separating the power head module, which is primarily an electrical module, from the deck, which is primarily a mechanical module, facilitates easier troubleshooting or maintenance of the power tool, since the modular power unit and the deck may be handled by electrical and mechanical engineers respectively and may be serviced or replaced separately.

The belt-drive transmission assembly eases the process of mounting the modular power unit to the deck. In addition, the belt-drive transmission assembly allows the weight of the deck to be distributed to achieve a better balance of the power tool, especially during the operation of the power tool. In particular, the use of the belt-drive transmission assembly rather than a direct coupling between a load (e.g., a cutting element) of the power tool to the motor allows a smaller motor to be used, and allows increased freedom of where the motor can be positioned with respect to deck.

The power tool may further comprise a switch operable by a user to activate and/or deactivate the motor. The modular power unit and the deck may be further configured such that the switch is electrically connected to the controller when the modular power unit is installed on the deck.

The power tool may further comprise a handle assembly attached to the deck. The switch may be operatively connected to the handle assembly.

The housing of the modular power unit may be configured to receive a battery for powering the motor.

The modular power unit may further comprise the battery.

The motor may be a brushless DC motor.

Advantageously, the belt-drive transmission assembly adapts the output of the motor to provide speed and torque conversions. With the belt-drive transmission assembly, a small volume brushless DC motor, which is able to achieve a high rotational speed and is generally of a low cost, may be used in the modular power unit to drive the power tool, thereby meeting the cost and performance target of the power tool.

The belt-drive transmission assembly may comprise a driving pulley which is operatively connectable to a shaft of the motor, a driven pulley, and a belt which couples the driven pulley to the driving pulley.

The driven pulley may have a diameter larger than that of the driving pulley. That is, the belt-drive transmission assembly reduces the rotational speed of the motor while increasing torque in the process.

The power tool may further comprise a cutting element rotationally supported on the deck and being operatively drivable by the driven pulley.

The driven pulley may be disposed between the driving pulley and an end of the deck attachable to a catcher. By arranging the belt-drive transmission assembly in this way, the heavier motor and the modular power unit is moved to a portion of the deck which results in a better balance of the power tool when the catcher is loaded.

The deck may further comprise a brake operatively coupled to the belt-drive transmission assembly.

The brake may be a mechanical braking device. The brake may be a frictional brake.

The brake may comprise a first braking surface mechanically linked to the belt-drive transmission assembly, and a second braking surface, the first and second braking surfaces being configured such that when the first and second braking surfaces are urged towards one another, friction between the first and second braking surfaces produces a braking force to the belt-drive transmission assembly.

The first braking surface may be mechanically linked to the driven pulley of the belt-drive transmission assembly.

The second braking surface may be fixedly attached to the housing of the power head module.

The brake may comprise a disc brake.

The disc brake may comprise a brake caliper attached to a driven pulley of the belt-drive transmission assembly, and a brake disc. The brake caliper may be configured to hold the brake disc so as to stop a rotation of the driven pulley.

That is, the brake caliper has the first braking surface, and the brake disc has the second braking surface.

The disc brake may further comprise a biasing member configured to urge the brake caliper towards the brake disc.

The biasing member may comprise a spring. The spring may be a tension spring.

The brake caliper and the biasing member may be configured such that when the driven pulley is rotating, a centrifugal force exerted on the brake caliper acts against a bias of the biasing member.

The brake disc may be fixedly attached to the housing of the power head module.

The brake caliper may be arranged radially outwards of the brake disc.

Where appropriate any of the optional features described above in relation to one of the aspects described herein may be applied to another one of the aspects described herein.

### BRIEF DESCRIPTION OF THE DRAWINGS

In order that the invention may be more fully understood, a number of embodiments of the present invention will now be described, by way of example, with reference to the accompanying drawings, in which:

FIG. 1 schematically illustrates a perspective view of a lawn mower;

FIG. 2 schematically illustrates a side-on cut-away view of the lawn mower of FIG. 1 taken along the line A-A′ shown in FIG. 1;

FIG. 3 schematically illustrates an exploded view of a housing of a power head module of the lawn mower of FIG. 1;

FIG. 4 schematically illustrates a perspective cut-away view of a part of the lawn mower of FIG. 1;

FIG. 5 schematically illustrates a perspective view of a belt-drive transmission assembly of the lawn mower of FIG. 1;

FIG. 6 schematically illustrates an exploded view of a part of the power head module and a mower deck of the lawn mower of FIG. 1;

FIGS. 7(A) and 7(B) schematically illustrate perspective views of a modular power unit for use with a power tool;

FIG. 8 schematically illustrates a mower which uses the modular power unit of FIG. 7;

FIG. 9 schematically illustrates a tiller which uses the modular power unit of FIG. 7; and

FIG. 10 schematically illustrates a brush cutter which uses the modular power unit of FIG. 7.

In the figures, like parts are denoted by like reference numerals.

It will be appreciated that the drawings are for illustration purposes only and are not drawn to scale.

### DETAILED DESCRIPTION OF THE PREFERRED EMBODIMENTS

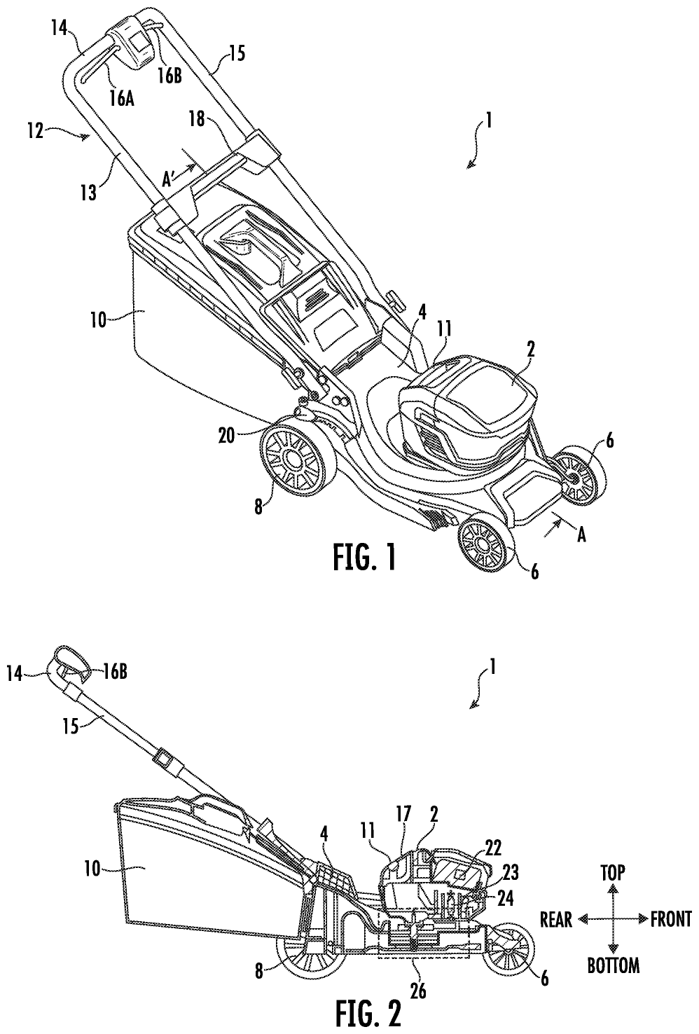

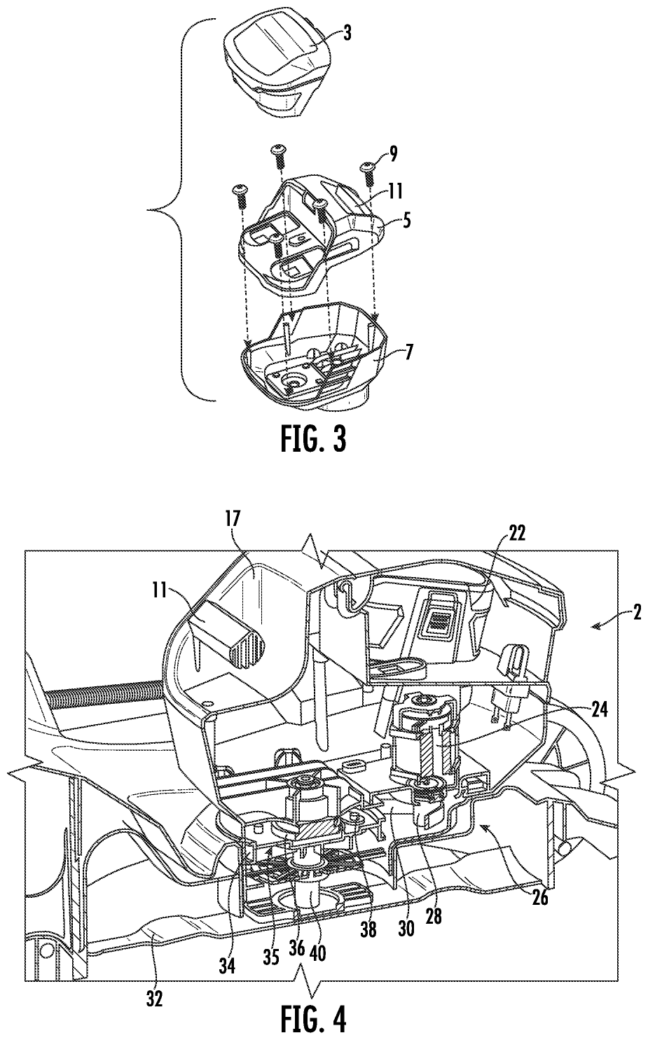

FIGS. 1 and 2 illustrate a lawn mower 1 including a power head module 2 installed on top of a mower deck 4. The power head module 2 is removable from the mower deck 4. The mower deck 4 is supported by a pair of front wheels 6 and a pair of rear wheels 8. The mower 1 further includes a cutting element 32 (shown in FIG. 3) which is rotationally supported on the mower deck 4 and is positioned below the main body of the mower deck 4. A grass catcher 10 is attached to a rear end of the mower deck 4 for collecting grass cut by the cutting element 32. The directions referred to by the terms “front”, “rear”, “top” and “bottom” in the following description are illustrated in FIG. 2, which shows an orientation of the lawn mower 1 in its normal use. The term “power head module” may be used interchangeably with the term “modular power unit”.

A handle assembly 12 is pivotally coupled to the mower deck 4 such that the handle assembly 12 may be rotated between discrete positions relative to the mower deck 4. The handle assembly 12 includes a pair of arms 13, 15 which are generally parallel to each other. The handle assembly 12 further includes a cross member 18 that extends transversely between the pair of arms 13, 15 to, among other things, provide lateral support for the handle assembly 12. The cross member 18 may be removably coupled to the pair of arms 13, 15, or may be integrally formed with the arms 13, 15.

The handle assembly 12 further includes a generally U-shaped grip 14 which is coupled to top ends of the arms 13, 15. A bail control 16 is also positioned on the grip 14. The bail control 16 includes a lever 16A and a lever 16B. One or both of the levers 16A, 16B may act as a switch, such that pulling the lever(s) against the grip 14 allows a motor 24 (described below) contained within the power head module 2 to be activated and that releasing the lever(s) stops the motor. Additional controls may be performed by the bail control 16. For example, one of the levers may be operated by a user to control a speed of the motor 24.

A height adjustment handle 20 is provided at a side of the mower I. By operating the handle 20, a user is able to adjust the height of the cutting element 32 between discrete positions relative to a surface on which the mower I stands.

The power head module 2 includes a recess 17 formed on a rear portion of the power head module 2, and a handle 11 extending across the recess 17. A user can easily lift up the power head module 2 by grabbing the handle 11. With reference to FIG. 3, the power head module 2 has a housing which is formed by a power head lid 3, a power head main body 5 and a power head base 7. The power head main body 5 and the power head base 7 are secured to each other by screws 9. The power head lid 3 is clipped onto the power head main body 5.

With further reference to FIG. 2, the power head module 2 includes an electrical motor 24, an electric controller 23 which controls an operation of the motor 24, and a battery pack 22 which supplies electric power to the controller 23 and the motor 24. The motor 24, the controller 23 and the battery pack 22 are enclosed within the housing of the power head module 2. More specifically, in the illustrated embodiment, the motor 24 and the controller 23 are received between the power head base 7 and the power head main body 5. The battery pack 22 is received within a cavity formed underneath the power head lid 3, so as to enable access to the battery pack 22 to be gained by removal of the power head lid 3. However, when the power head lid 3 is removed, controller and motor remain contained between main body and base. The controller 23 generally includes a processor and a memory (not shown), with the memory storing software setting forth operational parameters of the motor 24. The controller 23 may be referred to as an electric controller or a microcontroller. The motor 24 may be a DC motor. More particularly, the motor 24 may be a high speed brushless DC motor.

It will be appreciated that the battery pack 22 may be a standard component used interchangeably within many power tools, and the power head module 2 may be supplied to a user without having the battery pack 22 therein.

As described below, the motor 24 is used to drive the cutting element 32. The rear wheels 8 (and optionally the front wheels 6) of the mower 1 may be driven by the same motor 24. In an alternative embodiment, the power head module 2 may contain a second motor separate from the motor 24 for driving the wheels of the mower 1.

As shown in FIG. 2, the mower deck 4 includes a belt-drive transmission assembly 26 (described below) which is removably coupled to the motor 24 of the power head module 2.

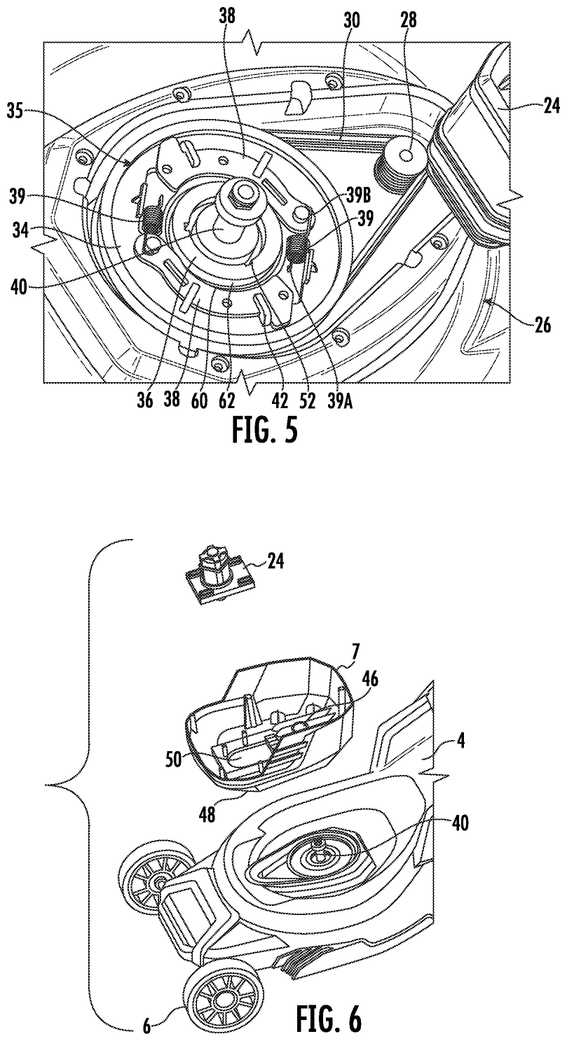

With further reference to FIGS. 4 and 5, the belt-drive transmission assembly 26 includes a driving pulley 28, a driven pulley 34 and a belt 30. The driven pulley 34 is coupled to the driving pulley 28 via the belt 30. The driving pulley 28 is coupled to a shaft of the motor 24. As such, in use, the motor 24 drives the driving pulley 28 to rotate, and the driving pulley 28 further drives the driven pulley 34 to rotate via the belt 30.

The driven pulley 34 is fixedly connected to and co-axial with a driven axle 40. A pair of brake calipers 38 are connected to an upper surface of the driven pulley 34 via respective biasing members 39. In particular, each of the biasing members 39 has a first end 39A which is secured to the upper surface of the driven pulley 34, and a second end 39B which is directly connected to a respective one of the brake calipers 38. Therefore, the driven axle 40, the brake calipers 38, and the biasing members 39 rotate together with the driven pulley 34, when the motor 24 drives the driving pulley 28 to rotate. The driven pulley 34, the driven axle 40, the brake calipers 38, and the biasing members 39 may be collectively referred to as a driven assembly 35.

As shown in FIG. 4, the cutting element 32 is fixedly connected to a bottom end of the driven axle 40. Therefore, the driven pulley 34 drives the cutting element 32 to rotate via the driven axle 40. in this way, the cutting element 32 is ultimately driven by the motor 24. In the belt-drive transmission assembly 26, the driven pulley 34 has a larger diameter than the driving pulley 28. The transmission ratio of the belt-drive transmission assembly 26 (i.e., a ratio between the revolutions of the driving pulley 28 and the revolutions of the driven pulley 34) is equal to a ratio of the diameter of the driven pulley 34 to the diameter of the driving pulley 28. The transmission ratio of the belt-drive transmission assembly 26 may be between 4:1 to 8:1. A particular example of the transmission ratio is 5.3695:1. The transmission ratio may be changed by changing the diameter of the driven pulley 34 and/or the diameter of the driving pulley 28.

By using the belt-drive transmission assembly 26, the cutting element 32 rotates at a lower speed and outputs a larger torque than the motor 24. With the belt-drive transmission assembly 26, a small volume brushless DC motor, which is able to achieve a high rotational speed and is generally of a low cost, may be used as the motor 24 to drive the cutting element 32 while meeting the cost and performance target of the mower 1.

With reference to FIG. 4, the driving pulley 28 is located at a front portion of the mower deck 4 and the driven pulley 34 is located at a rear portion of the mower deck 4. Therefore, when the power head module 2 is installed on the mower deck 4, the motor 24 is coupled to the driving pulley 28 at the front portion of the mower deck 4, in other words, the driven assembly 35 is located between the motor 24 and the grass catcher 10 during the operations of the mower 1. The motor 24, which generally has a substantial weight, counters the weight of the grass catcher 10 attached to the rear end of the mower deck 4, and results in a better balance of the mower 1 especially when the grass catcher 10 is loaded (i.e. when it is full of cut grass).

The mower deck 4 further includes a brake for stopping the rotation of the driven pulley 34 and the cutting element 32. With reference to FIG. 5, the brake includes the brake calipers 38, the biasing members 39 and a brake disc, 36. The brake may also be referred to as a disc brake. It will be appreciated that the disc brake is a mechanical brake, The brake disc 36 is secured to a bottom surface 48 of the power head base 7 (shown in FIG. 6), and stays stationary relative to the power head base 7 during the rotation of the driven pulley 34. The brake disc 36 may be secured to the bottom surface 48 of the power head base 7 in various suitable ways. In one example, the bottom surface 48 has a circular collar (not shown) provided thereon, and the brake disc 36 is secured to the outer surface of the circular collar. Further, a plurality of ribs may be provided on the outer surface of the circular collar. As shown in FIG. 5, the brake disc 36 has a plurality of grooves 52 provided on its inner surface. The grooves 52 may be sized and located to receive the ribs when the brake disc 36 is secured to the circular collar. The arrangement of the ribs and the grooves 52 ensures that the brake disc 36 does not rotate relative to the power head base 7.

As further shown in FIGS. 4 and 6, the power head base 7 has a hollow cylinder 46 extending vertically from the bottom surface 48. When the power head module 2 is mounted to the mower deck 4, the driven axle 40 is passed through the hole within the hollow cylinder 46, and the brake disc 36 surrounds the driven axle 40. As shown in FIG. 6, it will be appreciated that when the power head module 2 is removed from the mower deck 4, the belt-drive transmission assembly 26 is exposed.

With reference to FIG. 5, when the power head base 7 of the power head module 2 is installed onto the mower deck 4, the brake disc 36 and the brake calipers 38 are both within a common plane perpendicular to an axis of the driven axle 40. The brake calipers 38 provide a first braking surface 60 which is a radially inward surface of the brake calipers 38. The brake disc 36 provides a second braking surface 62 which is an outer circumferential surface of the brake disc 36. The biasing members 39 act upon the respective brake calipers 38 to urge the brake calipers 38 towards the brake disc 36, and more specially, to urge the first braking surface 60 towards the second braking surface 62. When the first and second braking surfaces 60, 62 are urged towards one another, friction between the surfaces produces a braking force to stop a rotation of the driven assembly 35. In the illustrated embodiment, the biasing members 39 are tension springs which pull the brake calipers 38 towards the brake disc 36. It will be appreciated that the biasing members 39 may take other suitable forms as long as they are able to urge the brake calipers 38 towards the brake disc 36.

When the driven assembly 35 is stationary, the brake calipers 38 hold the brake disc 36 tightly under the bias of the biasing members 39 such that the first and second braking surfaces 60, 62 are held against one another. When the driven assembly 35 is rotating, the brake calipers 38 experience centrifugal forces, the centrifugal forces acting against the bias of the biasing members 39 so as to urge the first braking surface 60 of the brake calipers 38 away from the second braking surface 62 of the brake disc 36. The driven assembly 35 further includes stoppers 42 attached to the upper surface of the driven pulley 34. The stoppers 42 are radially outwards of the brake calipers 33 and limit the movement of the brake calipers 38 when the centrifugal forces are greater than the bias of the biasing members 39. The stoppers 42 also act to retain the calipers 38 against the surface of the brake disc 36.

During the power up stage of the motor 24, the brake calipers 38 initially clamp the brake disc 36 to hold the driven assembly 35 stationary with respect to the power head base 7 of the power head module 2. That is, the first and second braking surfaces 60, 62 are held against one another and the brake is active initially. Subsequently, the motor 24 forcefully drives the driven assembly 35 to overcome a friction force between the first braking surface 60 of the brake calipers 38 and the second braking surface 62 of the brake disc 36. Once the rotational speed of the driven assembly 35 reaches a certain level, the centrifugal forces exerted on the brake calipers 38 overcome the bias of the biasing members 39 and pull the first braking surface 60 away from the second braking surface 62. As such, the brake is de-activated. Consequently, the cutting element 32 is driven by the motor 24 via the belt-drive transmission assembly 26.

During the power down stage of the motor 24, the brake calipers 38 are initially separated from the brake disc 36 (i.e. when the rotational speed of the driven assembly 35 is sufficient to cause the brake calipers 38 to be separated from the brake disc 36). That is, the first and second braking surfaces 60, 62 are separated from one another and the brake is inactive initially. Once the motor speed is reduced (e.g. when power is removed, or when the motor speed is controlled to be reduced under the control of the controller 23), the rotational speed of the driven assembly 35 decreases over time (e.g., due to the friction experienced by the various elements of the belt-drive transmission assembly 26) and accordingly the centrifugal forces exerted on the brake calipers 38 decrease over time. Once the rotational speed of the driven assembly 35 drops below a certain level, the bias of the biasing members 39 overcomes the centrifugal forces, and pull the brake calipers 38 towards to the brake disc 36 to clamp the brake disc 36. As such, the first and second braking surfaces 60, 62 are held against one another and the brake is activated. Consequently, the driven assembly 35 and the cutting element 32 stop rotating.

As described above, the brake is automatically deactivated when the motor 24 drives the driven assembly 35 to rotate, and is automatically activated when the motor 24 stops driving the driven assembly 35. In this way, the cutting element 32 is automatically stopped by the brake when the motor 24 stops driving, and accordingly potential safety hazards caused by continuing rotation of the cutting element 32 are effectively prevented.

Further, the structure of the brake determines that the brake is able to apply a variable braking force to the driven assembly 35 and the cutting element 32. The strength of the applied braking force depends upon a rotational speed of the driven assembly. For example, when the driven assembly 35 rotates at a very low speed, the first and second braking surfaces 60, 62 are held against one another tightly and therefore the braking force is relatively strong. When the driven assembly 35 rotates at a slightly higher speed, the first and second braking surfaces 60, 62 are held loosely against one another, and therefore the braking force is weak but not zero. The relationship between the strength of the applied braking force and the rotational speed of the driven assembly 35 is determined by a mass of the brake calipers 38, the bias of the biasing members 39, a geometry of the brake and the nature of the braking surfaces 60, 62, etc.

As described above, the brake reifies upon the friction between two braking surfaces 60, 62 to generate a braking force. The brake is therefore a frictional brake. It will be appreciated that one or both of the first and second braking surfaces 60, 62 may be suitably provided by other structures, such as, for example, a belt, a drum, etc. It will further be appreciated that the brake may take other suitable forms and may not even be a frictional brake.

With reference to FIG. 6, the power head base 7 of the power head module 2 includes an opening 50. The output shaft of the motor 24 extends through the opening 50. When the power head module 2 is installed on the mower deck 4, the shaft of the motor 24 is automatically coupled to a central bore of the driving pulley 28, thereby forming an operative connection between the motor 24 and the belt-drive transmission assembly 26. It will be appreciated that the connection between the power head module 2 and the belt-drive transmission assembly 26 is independent of the size of the mower deck 4, and therefore the same power head module 2 may be compatible with different mower decks, such as mower decks of different sizes.

Further, when the power head module 2 is installed onto the mower deck 4, an electrical connection is automatically formed between the controller 23 of the power head module 2 and the bail control 16, thereby allowing the bail control 16 to be operated to start or stop the operation of the motor 24. This may be achieved by, for example, providing a first electrical contact in the mower deck 4 which is electrically connected to the bail control 16 via a cable extending through the handle assembly 12, and meanwhile providing a second electrical contact in the power head module 2 which is electrically connected to an input of the controller 23. The first electrical contact and the second electrical contact are located such that they automatically connect when the power head module 2 is installed onto the mower deck 4. In an example, the first and second electrical contacts may resemble a plug and a socket.

In general, the power head module 2 is an electrical module and the mower deck 4 is a mechanical module of the mower 1. In particular, the power head module 2 contains the battery pack 22, the motor 24 and the controller 23 which sets forth the operations of the mower 1. The mower deck 4 contains the belt-drive transmission assembly 26, the brake, and the cutting element 32, all of which are mechanical components of the mower 1. The power head module 2 is separable from the mower deck 4. In this way, the mower 1 can be assembled in a modular manner. This modular design of the mower 1 facilitates easier troubleshooting or maintenance of the mower 1. In particular, the power head module 2 and the mower deck 4 may be handled by electrical engineers and mechanical engineers, respectively, and may be serviced, upgraded, or replaced separately.

Although FIGS. 1 to 6 relate to a lawn mower, it would be appreciated that the power head module 2, the belt-drive transmission assembly 26 and/or the brake described above may be used in other types of power tools (such as, for example, a tiller, a brush cutter, a trimmer, etc.).

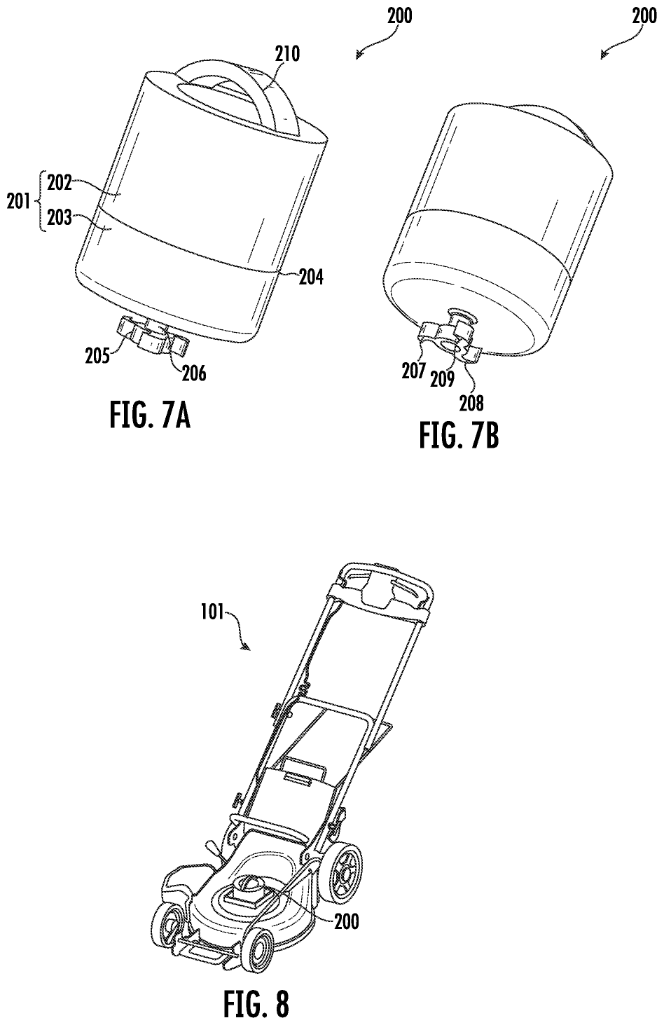

FIG. 7 illustrates a modular power unit 200 suitable for use with various types of power tools (such as, for example, a mower (similar to the mower 1 described above), a tiller, a brush cutter, a trimmer, etc.). The modular power unit 200 is a module similar to the power head module 2 described above. In general, the modular power unit 200 is removably attachable with a power tool.

As shown in FIG. 7(A), the modular power unit 200 includes a housing 201 and a handle 210 attached to the top of the housing 201. The housing 201 is of a generally cylindrical shape, and comprises a top housing 202 and a bottom housing 203 which are joined together at around a circular line 204. The top housing 202 and the bottom housing 203 may be joined in various ways, such as, gluing, using a bayonet mount arrangement, using threading, etc. In an example, the top housing 202 and the bottom housing 203 are releasably joined, thereby allowing the internal components of the modular power unit 200 to be accessed. A user can easily lift up the modular power unit 200 by grabbing the handle 210. 29. The generally cylindrical-shaped housing 201 provides a smooth outer surface and allows the modular power unit 200 to be easily handled, transported and stored. It will be appreciated, however, that the modular power unit 200 may be of any suitable shape (e.g., the shape of the power head module 2 as shown in FIGS. 1 and 3) which is not limited to the generally cylindrical shape shown in FIG. 7.

The modular power unit 200 further includes an electrical motor (similar to the motor 24) and an electric controller (similar to the controller 23) which controls an operation of the motor. The motor and the controller are enclosed within the housing 201 and are not shown in FIG. 7.

The housing 201 may further have a cavity formed therein (not shown in FIG. 7) for removably receiving a battery (similar to the battery pack 22). The battery supplies electric power to the controller and the motor.

Alternatively, the housing 201 may not receive any battery therein. Rather, a battery may be accommodated in a battery housing separate from the housing 201, making the battery a different unit from the modular power unit 200. Consequently, a power tool using the modular power unit 200 may be provided with a battery engaging feature which can receive the battery. The battery engaging feature may be configured to engage with a corresponding engaging feature provided by the battery, and may include a receptacle for holding the battery or a part of the battery. In general, the battery engaging feature allows the battery to be electrically connected to the modular power unit 200 mounted to the power tool.

With reference to FIG. 7(A), a rotatable shaft 206 protrudes from the bottom of the housing 201. The shaft 206 may be a shaft of the motor enclosed within the housing 201.

Alternatively, the modular power unit 200 may comprise a gearbox coupled to the motor and enclosed within the housing 201, and the shaft 206 may be an output shaft of the gearbox. In particular, the gearbox may have an input shaft coupled to the shaft of the motor. In an example, the gearbox may be a reduction gearbox and has a transmission ratio of N:1, with N>1. N may be any number between, for example, 3 to 100. Thus, the gearbox adapts the output of the motor to provide torque and speed conversions. In particular, a reduction gearbox reduces the rotational speed of the motor and enhances the output torque of the motor.

The motor enclosed within the housing 201 may be a brushless DC motor, in particular, a small-size high-speed brushless DC motor. A brushless DC motor is generally capable of achieving a high rotational speed at a relatively small size. Using the brushless DC motor together with the reduction gearbox, the modular power unit 200 is able to produce a relatively high torque and a reasonable rotational speed (which may be generally sufficient for the power tool) while allowing the modular power unit 200 to have a relatively small overall size. Accordingly, using the brushless DC motor together with the reduction gearbox within the modular power unit 200 may allow the modular power unit 200 to be used with a wide range of power tools.

In a further example, the reduction gearbox may be a planetary reduction gearbox. The planetary reduction gearbox may typically include a sun gear, planet gears supported by a carrier and driven by the sun gear to revolve around the sun gear, and a ring gear surrounding the planet gear and staying still. The planetary reduction gearbox may include an input shaft connected to the sun gear, and an output shaft connected to the carrier. The planetary reduction gearbox is beneficial in that the load exerted on the output shaft of the gearbox (by, for example, a power tool used with the modular power unit 200) is shared among the multiple planet gears. Thus, the planetary reduction gearbox may be able to drive a relatively heavy load.

With reference to FIG. 7(A), a coupling 205 is mounted to a bottom end of the rotatable shaft 206. The coupling 205 is used to couple the motor enclosed within the housing 201 to a power tool, thereby allowing the motor to drive the power tool.

With further reference to FIG. 7(B), the coupling 205 includes teeth 207, 208, 209 which are able to interlock with structures (e.g., recesses, protrusions) of a corresponding coupling formed on a rotational component (e.g., the driving pulley 28 described above) of the power tool. Once the teeth 207, 208, 209 interlock with the corresponding coupling of the power tool, a rotation of the shaft 206 causes a rotation of the coupling 205, which in turn causes the rotational component of the power tool to rotate so as to drive the power tool.

The coupling 205 may take any suitable form which is not limited to the example shown in FIG. 7, as long as the coupling 205 is able to transmit a rotation of the shaft 206 to a rotation of the power tool. For example, the coupling 205 may include any type of mateable formations which are engagable with complementary mateable formations of the corresponding coupling formed on the power tool.

The shaft 206 may be able to rotate in either a clockwise direction or an anti-clockwise direction under the control of the controller. In an example, the coupling 205 may be a bi-directional coupling. That is the coupling 205 may be configured to transmit each of a clockwise rotation and an anti-clockwise rotation of the shaft 206 to a corresponding rotation of the power tool. In an alternative example, the coupling 205 may be a uni-directional coupling. That is, the coupling 205 may be configured to couple the motor with the power tool only when the shaft 206 rotates in a particular rotational direction. When the shaft 206 rotates in an opposite direction, the coupling 205 will not couple the motor with the power tool and the motor cannot be used to drive the power tool. The coupling 205 and the corresponding coupling formed on the power tool may form a ratchet arrangement or a one-way clutch to allow the unidirectional coupling between the motor and the power tool.

In an example where the power tool has a transmission assembly (such as, the belt-drive transmission assembly 26 described above. a gearbox, or a gear train), the coupling 205 may couple the the shaft 206 to the transmission assembly of the power tool. Each particular type of power tools may have specific driven speed and torque requirements, which may be met by adjusting the output speed of the motor and/or adjusting the transmission ratio of the transmission assembly.

The power tool for use with the modular power unit 200 may comprise an identifier indicative of a characteristic of the power tool. The identifier may take any suitable form, such as, for example, a bar code, an RFID, an optical feature (e.g., an image), or a pattern of mechanical structures (e.g., an array of protrusions) with information encoded within the pattern. The identifier may indicate a type of the power tool, and/or may indicate driven speed and torque requirements of the power tool.

Similarly, the modular power unit 200 may comprise a reader which is able to read the identifier so as to obtain data indicative of a characteristic of the power tool. The form of the reader depends upon the particular identifier used by the power tool. For example, the reader may be a scanner for scanning a bar code, an RFID reader, an electromagnetic sensor (e.g., a camera), or force sensors for sensing a pattern of mechanical structures, etc.

In an example, the reader is provided on the coupling 205, and the identifier is provided on the corresponding coupling formed on the power tool. In this way, the reader of the modular power unit 200 is able to obtain the data indicative of a characteristic of the power tool when the coupling 205 couples the modular power unit 200 to the power tool. It will be appreciated, however, that the reader and the identifier may be provided at other locations of the modular power unit 200 and the power tool.

The obtained data indicative of a characteristic of the power tool may be transmitted from the reader to the controller of the modular power unit 200. The data transmission between the reader and the controller may be wired or wireless. Once the controller receives the data, the controller may control an operation of the motor based upon the received data. In particular, the controller may control a rotational speed and/or an output torque of the motor based upon the received data. In this way, the controller adjusts or optimises the operation of the motor based upon the characteristic of the power tool, and ensures that the specific driven speed and torque requirements of the power tool can be met.

The modular power unit 200 may further include a cooling mechanism (such as, a cooling fan and/or a heat sink) enclosed within the housing 201. The cooling mechanism may be used to cool at least one of the motor and the controller, so as to improve the heat dissipation of the modular power unit 200. The cooling mechanism thus allows the modular power unit 200 to adopt a relatively compact design.

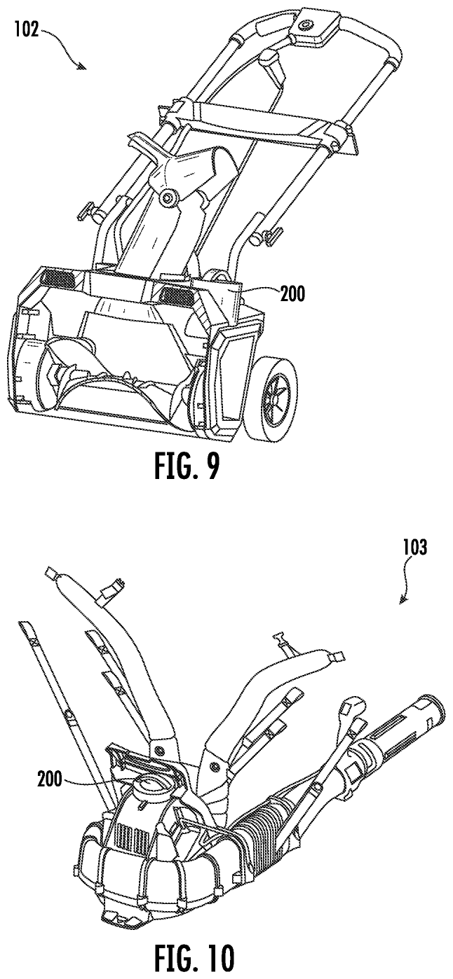

FIGS. 8 to 10 show that the modular power unit 200 is used with a mower 101, a tiller 102 and a brush cutter 103, respectively. As shown in the figures, each of the mower 101, the tiller 102 and the brush cutter 103 includes a receptacle (which is of a generally cylindrical shape) and the modular power unit 200 is supported within the receptacle for coupling to the respective tool. The handle 210 of the modular power unit 200 is exposed so as to allow easy removal of the modular power unit 200 by a user.

The modular power unit 200 may have a fastener for removably fastening the modular power unit 200 to the power tools 101, 102, 103 (e.g., the receptacles of the power tools). The fastener may be attached to the housing 201. Fastening the modular power unit 200 to a power tool ensures that the modular power unit 200 would not accidently fall out of the receptacle of the power tool. In an example, the modular power unit 200 is removably fastened to the receptacle via a bayonet mount arrangement. That is, the fastener may include pins extending radially outwards from the housing 201, and the receptacle of the power tool may have L-shaped slots formed in the inner surface. It will be appreciated that the fastener may take any suitable form which is not limited to the example provided above.

In general, the modular power unit 200 contains the motor and the controller controlling an operation of the motor, and is essentially an electrical module separable from the particular mechanical structures of the power tools 101, 102, 103. In this way, the modular power unit can be serviced, upgraded, or replaced separately from the power tools 101, 102, 103.

The skilled person will understand that in the preceding description and appended claims, positional terms such as ‘front’, ‘rear’, ‘top’, ‘bottom’, ‘above’, ‘below’, ‘upper’, ‘lower’, ‘lateral’, ‘vertical’, ‘forward’ etc. are made with reference to conceptual illustrations of a power tool, such as those in normal use and/or those shown in the appended drawings. These terms are used for ease of reference but are not intended to be of limiting nature. These terms are therefore to be understood as referring to a mower when in an orientation as shown in the accompanying drawings.

Although the invention has been described in terms of preferred embodiments as set forth above, it should be understood that these embodiments are illustrative only and that the claims are not limited to those embodiments. Those skilled in the art will be able to make modifications and alternatives in view of the invention which are contemplated as falling within the scope of the appended claims. Each feature disclosed or illustrated in the present specification may be incorporated in the invention, whether alone or in any appropriate combination with any other feature disclosed or illustrated herein.

1. A modular power unit for use with a power tool, comprising:
a housing;
a motor; and
a controller arranged to control an operation of the motor;
wherein the motor and the controller are at least partially enclosed by the housing.

2. A modular power unit according to claim 1, further comprising:
a coupling which is operable to couple the motor to the power tool so as to allow the motor to drive the power tool.

3. A modular power unit according to claim 2, wherein the coupling is operable to couple the motor to a transmission assembly of the power tool.

4. A modular power unit according to claim 1, further comprising a reduction gearbox coupled to the motor.

5. A modular power unit according to claim 1, wherein the motor is a brushless DC motor.

6. A modular power unit according to claim 1, wherein the controller is configured to:
receive data indicative of a characteristic of the power tool to be used with the modular power unit, and
control an operation of the motor based upon the received data.

7. A modular power unit according to claim 6, further comprising a reader which is arranged to obtain the data indicative of a characteristic of the power tool by interacting with an identifier of the power tool.

8. A modular power unit according to claim 7, wherein the reader is provided on the coupling.

9. A modular power unit according to claim 1, further comprising a cooling mechanism configured to cool at least a part of the modular power unit.

10. A modular power unit according to claim 1, further comprising a fastener for removably fastening the modular power unit to the power tool.

11. A modular power unit according to according to claim 1, wherein the housing is of a generally cylindrical shape.

12. A modular power unit according to according to claim 1, wherein the housing is configured to removably receive a battery for powering the motor.

13. A modular power unit according to according claim 1, further comprising a battery for powering the motor.

14. A power tool comprising a modular power unit according to claim 1.

15. A power tool according to claim 14, further comprising a coupling for engaging with a coupling of the modular power unit.

16. A power tool according to claim 14, further comprising an identifier indicative of a characteristic of the power tool.

17. A power tool according to claim 14, further comprising a battery engaging feature configured to receive a battery for powering the modular power unit.

18. A power tool according to claim 14, further comprising:
a deck comprising a belt-drive transmission assembly;
wherein the modular power unit is removably installable on the desk, and wherein the power head module and the deck are configured such that the motor is operatively connected to the belt-drive transmission assembly when the power head module is installed on the deck.

19. A power tool according to claim 18, further comprising a switch operable by a user to activate and/or deactivate the motor, and wherein:
the modular power unit and the deck are further configured such that the switch is electrically connected to the controller when the modular power unit is installed on the deck.

20. A power tool according to claim 18, wherein the belt-drive transmission assembly comprises a driving pulley which is operatively connectable to a shaft of the motor, a driven pulley, and a belt which couples the driven pulley to the driving pulley.

21. A power tool according to claim 20, the driven pulley has a diameter larger than that of the driving pulley.

22. A power tool according to claim 20, further comprising a cutting element rotationally supported on the deck and being operatively drivable by the driven pulley.

23. A power tool according to claim 20, wherein the driven pulley is disposed between the driving pulley and an end of the deck attachable to a catcher.

24. A power tool according to claim 18, wherein the deck further comprises a brake operatively coupled to the belt-drive transmission assembly.

25. A power tool according to claim 24, wherein the brake comprises a first braking surface mechanically linked to the belt-drive transmission assembly, and a second braking surface, the first and second braking surfaces being configured such that when the first and second braking surfaces are urged towards one another, friction between the first and second braking surfaces produces a braking force to the belt-drive transmission assembly.

26. A power tool according to claim 24, wherein the brake comprises a disc brake.

27. A power tool according to claim 26, wherein the disc brake comprises a brake caliper attached to a driven pulley of the belt-drive transmission assembly, and a brake disc, wherein the brake caliper is configured to hold the brake disc so as to stop a rotation of the driven pulley.

28. A power tool according to claim 27, wherein the disc brake further comprises a biasing member configured to urge the brake caliper towards the brake disc.

29. A power tool according to claim 28, wherein the biasing member comprises a spring.

30. A power tool according to claim 28, wherein the brake caliper and the biasing member are configured such that when the driven pulley is rotating, a centrifugal force exerted on the brake caliper acts against a bias of the biasing member.

31. A power tool according to claim 27, wherein the brake disc is fixedly attached to the housing of the modular power unit.

32. A power tool according to claim 27, wherein the brake caliper is arranged radially outwards of the brake disc.

33. A power tool according to claim 14, wherein the power tool is an electric mower.
